(19) United States
(12) Patent Application Publication
(10) Pub. No.: US 2026/0243623 A1
(43) Pub. Date: Aug. 20, 2026

(54) CONTROL VALVE SEAT LEAK DETECTION METHOD

(71) Applicant: FUJIKIN INCORPORATED, Osaka (JP)

(72) Inventors: Katsuyuki SUGITA, Osaka-shi (JP); Kaoru HIRATA, Osaka-shi (JP); Shinya OGAWA, Osaka-shi (JP); Masayoshi KAWASHIMA, Osaka-shi (JP); Kouji NISHINO, Osaka-shi (JP)

(73) Assignee: FUJIKIN INCORPORATED, Osaka (JP)

(21) Appl. No.: 18/876,005

(22) PCT Filed: Jun. 5, 2023
(86) PCT No.: PCT/JP2023/020791

§ 371 Date: Oct. 17, 2025

(30) Foreign Application Priority Data
Jun. 29, 2022 (JP) 2022-104288

(51) Int. Cl. G01M 3/28

(52) U.S. Cl. CPC G01M 3/2876

(57) ABSTRACT

A seat leak detection method includes: a step (a) of closing an upstream on-off valve and a downstream on-off valve and inputting a set flow rate of 0% or a control valve forced close signal into a flow rate control device; a step (b) of measuring a supply pressure, an upstream pressure, or a downstream pressure at a first time point; a step (c) of measuring the supply pressure, the upstream pressure, or the downstream pressure at a subsequent second time point; and a step (d) of detecting a seat leak in the control valve based on a pressure variation of the supply pressure, the upstream pressure, or the downstream pressure. In step (d), if the pressure variation of the supply pressure, the upstream pressure, or the downstream pressure between the first time point and second time point exceeds a threshold, monitoring is performed to observe whether a set flow rate other than a set flow rate of 0% or a signal other than the control valve forced close signal has been input between the second time point and a third time point that is after the second time point. If such a signal has been input, the seat leak detection flow is terminated. On the other hand, if the flow rate of 0% is being maintained, the supply pressure, the upstream pressure, or the downstream pressure is measured again at the third time point to detect seat leak.

### TECHNICAL FIELD

The present invention relates to a seat leak detection method in a control valve of a flow rate control device.

### RELATED ART

In a semiconductor manufacturing facility or a chemical plant, etc., there is a demand for supplying a raw material gas or an etching gas to a process chamber at a desired flow rate. As a gas flow rate control device, a mass flow controller (thermal mass flow controller) and a pressure type flow rate control device are known.

The pressure type flow rate control device is widely used because of its capability of controlling mass flow rates of various types of fluids with high precision through a relatively simple configuration, that is a combination of a control valve and a restriction part (e.g., an orifice plate or a critical nozzle). The pressure type flow rate control device has an excellent flow rate control characteristic that allows for stable flow rate control even when a primary side supply pressure fluctuates significantly.

Among the pressure type flow rate control devices, there is one that adjusts the flow rate by controlling a fluid pressure upstream of the restriction part (hereinafter, may be referred to as upstream pressure P1). The upstream pressure P1 is controlled by controlling the opening degree of the control valve provided in a flow path upstream of the restriction part.

As the control valve, for example, a piezoelectric element driven valve configured to open and close a diaphragm valve element by a piezo actuator may be used. The piezoelectric element driven valve has high responsiveness, by feedback controlling the piezoelectric element driven valve based on the upstream pressure P1, the flow rate of gas flowing downstream of the restriction part can be appropriately controlled.

Furthermore, in order to perform flow rate control accurately over a wider flow range, development is undergoing on a pressure type flow rate control device in which a restriction part and a control valve are provide in each of parallel flow paths branching from the upstream flow path (for example, Patent Literature 1). The parallel flow paths are provided with restriction parts for high flow rate and for low flow rate, and gas supply can be switched between a high flow rate range and a low flow rate range by controlling the opening and closing of the parallel flow paths.

### PRIOR-ART DOCUMENTS

### Patent Documents

[Patent Literature 1] International Publication No. WO2018/070464

[Patent Literature 2] Japanese Laid-Open Patent Publication No. JP2020-87164

### SUMMARY OF INVENTION

### Technical Problem

In the flow rate control device provide with parallel flow paths as described above, when flowing gas in one flow path at a controlled flow rate, the control valve in the other flow path may be completely closed to block the flow path. For example, when performing flow rate control in a low flow range by opening only the flow path for low flow rates, accurate flow rate control requires that the control valve provided in the flow path for high flow rates is usually kept completely closed.

However, even when the control valve is closed, the tightness between the diaphragm valve element and the seat (valve seat) may not be perfect, and in such a case, seat leak (leakage from the gap between the valve element and the seat when the valve is closed) may occur. Seat leak may not occur in the initial stage of using the device, but may occur over time due to aging from repeated opening and closing of the valve. Furthermore, seat leak may occur and increase over time due to the formation of gas deposits on the valve element and the valve seat, or due to changes and deformations caused by corrosion.

Especially in the flow rate control device provided with parallel flow paths as described above, ability of seat leak detection is preferable because it can significantly affect the controlled flow rate during gas supply. Further, a conventional pressure type flow rate control device is designed to control flow rate through pressure control and must be provided with a pressure sensor, but it often lack means to directly measure flow rate. Therefore, it would be advantageous to be able to detect seat leak in control valve using the existing configuration without having to add any additional components to the conventional contracture for leak measurement.

In response to the issue of seat leak occurrence, Patent Document 2 by the present applicant discloses a seat leak detection method in a control valve provided in the parallel flow paths. Here, an upstream on-off valve provided in a common flow path upstream of the parallel flow paths and a downstream on-off valve provided in a common flow path downstream of the parallel flow paths are closed to form a sealed space including the parallel flow paths. Also, the control valves provided in each of the parallel flow paths are closed simultaneously.

In this case, if no seat leak has occurred, the pressure upstream of the control valve and the pressure downstream of the control valve should be maintained at a constant value. On the other hand, if a seat leak occurs, the pressure upstream of the control valve will decrease over time, while the pressure downstream of the control valve will increase. Therefore, by monitoring the changes in these pressures over time, it is possible to detect the occurrence of seat leak.

However, it has been confirmed by the inventors that in the seat leak detection method described in Patent Document 2, false detection may occur depending on the detection timing by only monitoring the pressure variation at the time of sealing the flow path.

The present invention is made to solve the above-mentioned problem and aims to provide a method for preventing false detection and detecting a seat leak in a control valve provided in a flow rate control device more accurately.

### Solution to Problem

The seat leak detection method according to embodiments of the present invention is performed in a fluid system comprising a flow rate control device including a control flow path having a restriction part, a control valve provided upstream of the restriction part, and a first pressure sensor provided between the control valve and the restriction part to measure an upstream pressure; a second pressure sensor provided downstream of the restriction part to measure a downstream pressure, and an inflow pressure sensor provided upstream of the control valve to measure a supply pressure; a downstream on-off valve provided downstream of the second pressure sensor, and an upstream on-off valve provided upstream of the inflow pressure sensor. The method includes a step (a) of closing the upstream on-off valve and the downstream on-off valve, and inputting a set flow rate of 0% or a control valve forced close signal to the flow rate control device in a state where the supply pressure is greater than the downstream pressure; a step (b) of measuring at least one of the supply pressure, the upstream pressure, and the downstream pressure at a first time point after step (a) by using at least one of the inflow pressure sensor, the first pressure sensor, and the second pressure sensor t; a step (c) of measuring at least one of the supply pressure, the upstream pressure, and the downstream pressure at a second time point that is after the first time point; and a step (d) of detecting seat leak in the control valve based on a pressure variation of at least one of the supply pressure, the upstream pressure, and the downstream pressure measured in steps (b) and (c). The step (d) includes a step of monitoring whether a set flow rate other than the set flow rate of 0% or a signal other than the control valve forced close signal input has been input between the second time point and a subsequent third time point, in a case where the pressure variation of at least one of the supply pressure, the upstream pressure, and the downstream pressure between the first time point and the second time point exceeds a threshold; a step of terminating the seat leak detection flow when a flow rate other than the set flow rate of 0% or a signal other than the control valve forced close signal has been input between the second time point and the third time point; a step of measuring at least one of the supply pressure, the upstream pressure, and the downstream pressure again at the third time point, when the set flow rate of 0% or the control valve forced close signal is maintained between the second time point and the third time point; and a step of using at least one of the supply pressure, the upstream pressure, and the downstream pressure measured at the third time point to detect seat leak.

In an embodiment, multiple control flow paths are provided in parallel between a common inflow path and a common outflow path.

In an embodiment, measurements of the supply pressure and the downstream pressure are performed at the first time point, the second time point, and the third time point, and seat leak detection is performed based on both a pressure change of the supply pressure and a pressure variation of the downstream pressure.

In an embodiment, the seat leak detection method further includes a step of issuing an alarm when a seat leak is detected.

In an embodiment, the step (d) includes a step of detecting a seat leak based on the pressure variation obtained from at least one measurement result of the supply pressure, the upstream pressure, and the downstream pressure at the third time, and at least one measurement result of the supply pressure, the upstream pressure, and the downstream pressure at the first time point.

In an embodiment, based on at least one of the pressure variation of the supply pressure, the upstream pressure, and the downstream pressure measured in the steps (b) and (c), if no seat leak in the step (d) has been determined, detections are repeated during the period when the set flow rate of 0% is maintained by performing measurement on at least one of the supply pressure, the upstream pressure, and the downstream pressure again after a detection interval, which is the time period from the first time point to the second time point.

### Effect of Invention

According to the embodiments of the present invention, it is possible to more accurately and appropriately perform seat leak detection in a control valve of a flow rate control device in a fluid system.

### BRIEF DESCRIPTION OF DRAWINGS

FIG. 1 is a diagram showing a flow rate control device of a comparative example.

FIG. 2 is a diagram for explaining the seat leak detection method performed in the flow rate control device of the comparative example shown in FIG. 1, where (a) shows a case in which no seat leak has occurred, and (b) shows a case in which a seat leak has occurred.

FIG. 3 is a diagram for explaining a more specific aspect of the seat leak detection method of the comparative example.

FIG. 4 is a diagram for explaining an operation of a false detection that may occur in the seat leak detection method of the comparative example.

FIG. 5 is a schematic diagram of a fluid system including a flow rate control device according to an embodiment of the present invention.

FIG. 6 is a schematic diagram of a flow rate control device according to an embodiment of the present invention.

FIG. 7 is a diagram for explaining an improved seat leak detection method performed in the flow rate control device according to an embodiment of the present invention.

FIG. 8 is a flowchart of the improved seat leak detection method according to an embodiment of the present invention.

### DESCRIPTION OF EMBODIMENTS

First, before explaining the embodiments of the present invention, the seat leak detection method (comparative example) previously conducted by the applicant and the mechanism of the false detection that may occur in the method of the comparative example will be explained.

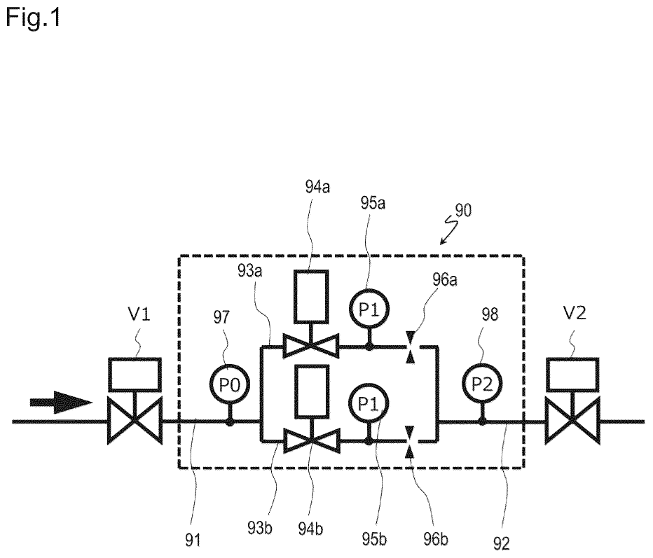

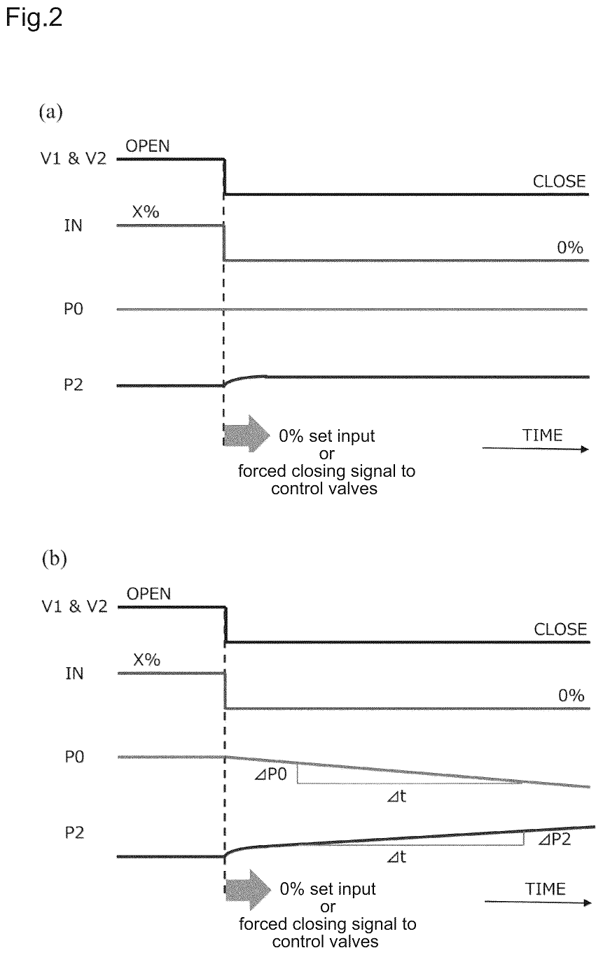

FIG. 1 shows a configuration of the flow rate control device 90 of the comparative example. Also, FIG. 2(a) and 2(b) show an opening and closing operation of each valve and the time changes in the supply pressure PO and the downstream pressure P2 during the seat leak detection process. FIG. 2(a) shows the case with no seat leak, and FIG. 2(b) shows the case with a seat leak.

As shown in FIG. 1, the flow rate control device 90 has a common inflow path 91 and a common outflow path 92, and a first flow path 93a and a second flow path 93b provided as parallel flow paths between the common inflow path 91 and the common outflow path 92. Control valves 94a, 94b, first pressure sensors 95a, 95b, and restriction parts 96a, 96b are provided in each of the parallel flow paths 93a, 93b respectively. Furthermore, an inflow pressure sensor 97 for measuring the supply pressure PO upstream of the control valves 94a, 94b is provided in the common inflow path 91, and a second pressure sensor 98 for measuring the downstream pressure P2 downstream of the restriction parts 96a, 96b is provided in the common outflow path 92.

In the flow rate control device 90, when the control valve 94b of the second flow path 93b is completely closed, by adjusting the opening degree of the control valve 94a based on an output of the first pressure sensor 95a (upstream pressure P1), it is possible to supply gas at a controlled flow rate in a large flow range through the restriction part 96a having a relatively large diameter provided in the first flow path 93a. Furthermore, when the control valve 94a of the first flow path 93a is completely closed, by adjusting the opening degree of the control valve 94b based on an output of the first pressure sensor 95b (upstream pressure P1), it is possible to supply gas at a controlled flow rate in a small flow range through the restriction part 96b having a relatively small diameter provided in the second flow path 93b.

In addition, an upstream on-off valve V1 is provided upstream of the flow rate control device 90, and a downstream on-off valve V2 is provided downstream of the flow rate control device 90. The fluid system including the flow rate control device 90 is configured to be able to block the flow path on both the upstream and downstream sides of the flow rate control device 90.

As shown in FIG. 2(a) and 2(b), in the flow rate control device 90, seat leak detection in control valves 94a, 94b is performed by simultaneously closing the upstream on-off valve V1 and the downstream on-off valve V2, and closing one of the control valves 94a, 94b which is open. The closing operation is performed by changing the set flow input IN from an arbitrary X% to 0%, or inputting a forced closing signal to the control valves 94a, 94b. Hereinafter, a description of the forced closing signal input to the control valves 94a, 94b will be omitted, and the configuration with the set flow rate at 0% will be described in this specification. In a state where flow control is being performed at an arbitrary X%, the other one of the control valves 94a, 94b that is not used for flow control is usually closed. The flow rate control device 90 can perform the seat leak detection step at a timing when the control flow rate becomes 0%, such as during a period when gas supply is stopped.

As shown in FIG. 2(a), in the event of no seat leak, when each valve V1, V2, 94a, 94b is closed, the supply pressure PO is considered to be maintained at approximately the same constant value as that before the valves were closed. Furthermore, the downstream pressure P2 downstream of the restriction parts 96a, 96b is also considered to be maintained at a generally constant value after initially rising slightly.

The reason for the initial rise in the downstream pressure P2 is that the upstream pressure P1 between the open control valves 94a, 94b and the corresponding restriction parts 96a, 96b is greater than the downstream pressure P2, and gas continues to flow in slightly through the restriction parts 96a, 96b even after the control valves 94a, 94b are closed. Then, after a certain period of time, the differential pressure across the restriction parts 96a, 96b is eliminated, so the upstream pressure P1 and the downstream pressure P2 become the same. Furthermore, as long as the upstream on-off valve V1 and the downstream on-off valve V2 remain closed, the upstream pressure P1 and the downstream pressure P2 are usually maintained at the same level.

On the other hand, as shown in FIG. 2(b), in the event of a seat leak occurs, when each valve V1, V2, 94a, 94b is closed, the supply pressure P0 upstream of the control valve decreases over time. To the contrary, the upstream pressure P1 and the downstream pressure P2 increase over time.

Therefore, in a flow path sealed state after the valves are closed, during the pressure stabilization period after a predetermined time has elapsed, it is possible to detect the occurrence of a seat leak by measuring the time change in the supply pressure PO and the time change in the downstream pressure P2 (or the upstream pressure P1).

Furthermore, as shown in FIG. 2(b), in the event of a seat leak, a slope of ΔP0/Δt or ΔP2/Δt changes depending on the leak flow rate. More specifically, ΔP0/Δt or ΔP2/Δt is considered to be generally proportional to a mass flow rate of the leak gas. Therefore, it is also possible to estimate the leak flow rate from the measured slope of ΔP0/Δt or ΔP2/Δt, and by adding this to the normal flow rate, a corrected flow rate as a more accurate flow rate can be obtained.

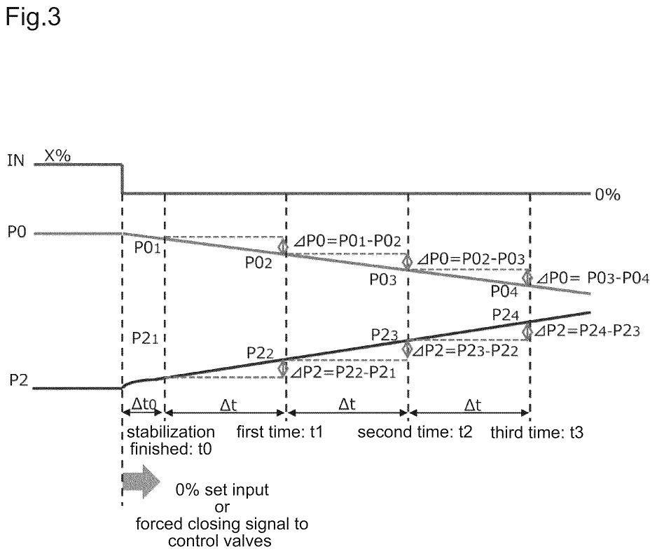

FIG. 3 is a diagram showing an example of a more specific seat leak detection step. Here, as shown in FIG. 3, in order to start the seat leak detection, a 0% flow rate setting is input, and although not shown here, the upstream on-off valve V1 and the downstream on-off valve V2 are also closed simultaneously.

Then, at time to, which is a time after a predetermined initial time Δₜ₀ (for example, 1 to 5 seconds) has elapsed until the pressure stabilizes, the first pressure measurement of the supply pressure P0 and the downstream pressure P2 is performed. The obtained pressure values P0₁ and P2₁ are stored in a memory. Next, at time t1, which is a time waiting for a possible pressure variation has elapsed after a predetermined time Δt (for example, 30 to 60 seconds), the next pressure measurement of the supply pressure P0 and the downstream pressure P2 is performed to obtain pressure values P0₂ and P2₂.

Then, by comparing the pressure values at time t0 with the pressure values at time t1, the first seat leak detection is performed. In this example, a pressure difference P0₁−P0₂ is obtained as the pressure variation ΔP0, and a pressure difference P2₂−P2₁ is obtained as the pressure variation ΔP2.

Here, if the pressure variation ΔP0 exceeds a predetermined threshold (for example, 1.0 kPa) and the pressure variation ΔP2 exceeds a predetermined threshold (for example, 1.5 kPa), it is determined that a seat leak has occurred, an alarm is issued to notify the user, and the device is terminated due to the malfunction.

Similarly, a second detection is performed at time t2 after the same predetermined time Δt has elapsed, where P0₃ and P2₃ are measured, and if ΔP0 (=P0₂−P0₃) and ΔP2 (=P2₃−P2₂) exceed the thresholds, it is determined that there is a seat leak. Also, a third detection is performed at time t3 after the same predetermined time Δt has elapsed, where P0₄ and P2₄ are measured, and if ΔP0 (=P0₃−P0₄) and ΔP2 (=P2₄−P2₃) exceed the thresholds, it is determined that there is a seat leak.

As described above, by conducting multiple detections at predetermined intervals, it is possible to more reliably detect the occurrence of a seat leak. However, it was found that when the timing of the detection coincides with the timing of opening the valve after the detection and starting the gas supply at the control flow rate again, a seat leak may be falsely detected even though there is no seat leak actually occurs.

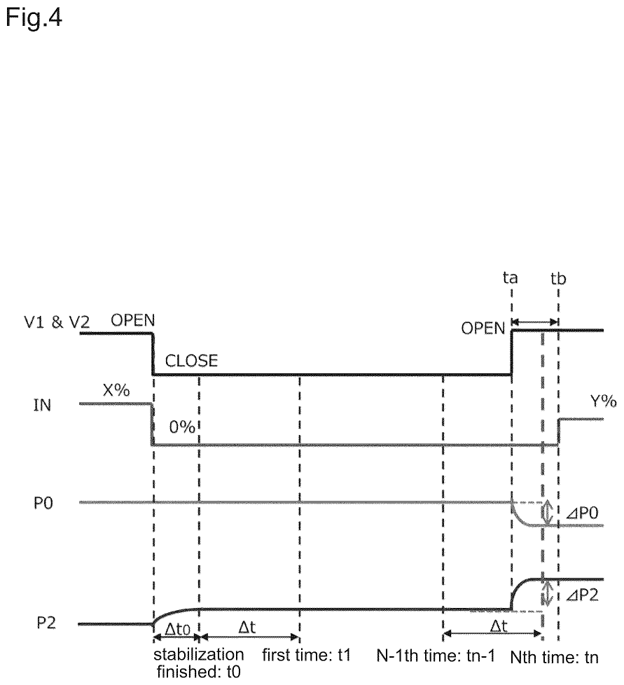

FIG. 4 is a diagram explaining the mechanism by which a false detection occurs due to the accidental overlap of the timing of the Nth detection and the period of returning to the normal flow rate control after the detection, when performing multiple seat leak detections.

As shown in FIG. 4, detections from the first time to the N-1th time are conducted as usual as shown in FIG. 3 where no seat leak occurs, the supply pressure P0 and the downstream pressure P2 are generally maintained at an constant value after closing each valve. In this situation, at each detection timing, since the pressure variations ΔP0 and ΔP2 do not exceed the thresholds, no alarm is issued.

However, after the N-1th time of detection, just before conducting the Nth time detection at time tn after the predetermined time At has elapsed, an order to return to the normal operation at an arbitrary control flow rate Y% may be issued. In this case, at time ta, the upstream on-off valve V1 and the downstream on-off valve V2 are simultaneously opened, and gas flowing from the upstream side is flow-rate controlled by the flow rate control device 90 and flows to the downstream side.

However, in reality, delay in the operation control of the flow rate control device 90 may occur, and at time ta when a command is received, the control valves 94a, 94b may not yet open. In this case, if the timing of the Nth time detection accidentally falling in the period until time tb when the actual opening and closing control of the control valve starts and the operation control at the control flow rate Y% is performed (for example, within 1 second), since the controlled flow rate is recognized as 0% due to the operation delay, there may be cases, although not many, where the Nth time detection is carried out but not being canceled.

In addition, an exhaust line may be provided upstream of the flow rate control device 10, and the upstream side may be exhausted at the timing of changing the control flow rate. Therefore, when opening the upstream on-off valve V1 at time ta, the supply pressure P0 may decrease due to the exhaustion. On the other hand, a supply line for dilution gas and the like may be provided downstream of the flow rate control device 10. Therefore, when opening the downstream on-off valve V2 at time ta, the downstream pressure P2 may increases if the pressure downstream of the downstream on-off valve V2 is higher.

Then, in the Nth detection conducted after opening both the upstream on-off valve V1 and the downstream on-off valve V2, as shown in FIG. 4, the supply pressure P0 may decrease below the threshold, and the downstream pressure P2 may increase above the threshold. Therefore, even though there is actually no seat leak, the changes in the supply pressure P0 and the downstream pressure P2 may satisfy the condition expression for seat leak determination, resulting in false detection.

As described above, in the transition period from a set flow rate of 0% to an arbitrary flow rate of Y% during the detection period, delay in the control of the flow rate control device 90 may occur, and if the timing of seat leak detection coincidentally overlaps during this delay period, false detection may occur. Further, when a seat leak is falsely detected, an alarm is triggered, which usually results in terminating the operation of the device. In this case, in the semiconductor manufacturing process, wafers in the chamber are treated as defective, causing significant damage.

On the contrary, in the seat leak detection method according to the embodiments of the present invention described below, the alarm is not triggered immediately even if the alarm activation conditions are met initially to prevent false detection at the detection timing just before switching the flow rate, as mentioned above. Instead, a re-detection is conducted after a set period, and it is decided whether or not to trigger the alarm based on the results.

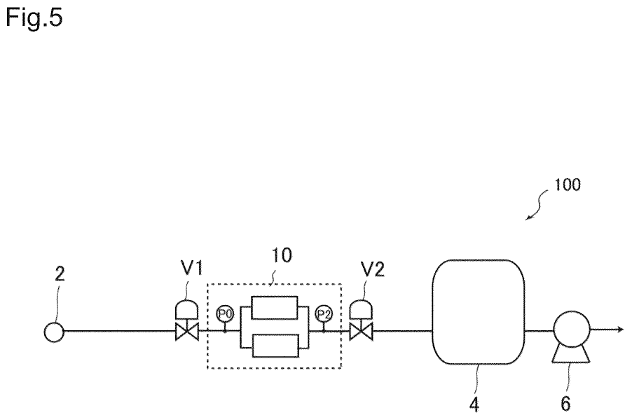

FIG. 5 shows a fluid system 100 including a flow rate control device 10 in which the seat leak detection method according to the embodiments of the present invention is performed. The fluid system 100 includes a gas supply source 2, the flow rate control device 10 for controlling the flow rate of the gas supplied from the gas supply source 2, a process chamber 4 to which the gas is supplied via the flow rate control device 10, and a vacuum pump 6 connected to the process chamber 4.

The vacuum pump 6 is used to evacuate the process chamber and the flow path. Various types of gases used in the semiconductor manufacturing process, such as raw material gas, etching gas, or carrier gas, are supplied to the process chamber 4 from the gas supply source 2. Although only one gas supply line is shown in FIG. 5, there is no need to say that a number of gas supply lines may be connected to the process chamber 4.

In the fluid system 100, an upstream on-off valve V1 is provided upstream of the flow rate control device 10, and a downstream on-off valve V2 is provided downstream of the flow rate control device 10. The fluid system 100 is configured to be able to shut off the flow paths both upstream and downstream of the flow rate control device 10. For the upstream on-off valve V1 and the downstream on-off valve V2, it is preferable to use valves with good shut-off performance and responsiveness, such as air operated valves (AOVs), solenoid valves, or motorized valves.

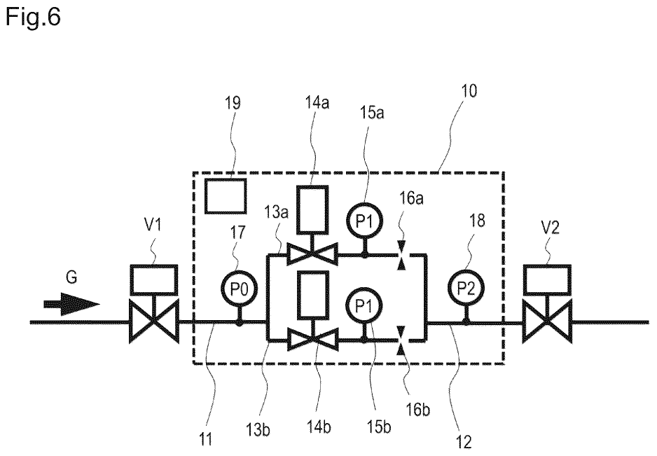

FIG. 6 shows the flow rate control device 10, the upstream on-off valve V1, and the downstream on-off valve V2 in the fluid system 100 shown in FIG. 5. In the illustrated embodiment, the upstream on-off valve V1 and the downstream on-off valve V2 are provided outside the flow rate control device 10, but they may also be incorporated inside the flow rate control device 10.

As shown in FIG. 6, the flow rate control device 10 has a common inflow path 11 and a common outflow path 12, and a first flow path 13a and a second flow path 13b provided as parallel flow paths 13a, 13b between the common inflow path 11 and the common outflow path 12. The parallel flow paths 13a, 13b are provided with control valves 14a, 14b, first pressure sensors (upstream pressure sensors for measuring upstream pressure P1) 15a, 15b, and restriction parts 16a, 16b, each being used as flow paths for flow rate control. Each of the flow paths 11, 12, 13a, 13b may be formed, for example, by small holes in a metal block, but is not limited to this and may also be formed by piping.

In addition, an inflow pressure sensor 17 for measuring the supply pressure P0 upstream of the control valves 14a, 14b, is provided in the common inflow path 11, and a second pressure sensor (downstream pressure sensor) 18 for measuring the downstream pressure P2 downstream of the restriction parts 16a, 16b is provided in the common outflow path 12. The flow rate control device 10 may have a configuration same as that of the flow rate control device 90 shown in the comparative example of FIG. 1.

The inflow pressure sensor 17 may be provided in either of the parallel flow paths 13a, 13b instead of in the common inflow path 11, as long as it is upstream of the control valves 14a, 14b. Also, the second pressure sensor 18 may be provided in either of the parallel flow paths 13a, 13b instead of in the common outflow path 12, as long as it is downstream of the restriction parts 16a, 16b.

Although not shown, the flow rate control device 10 may also be provided with a temperature sensor for measuring the temperature of the gas. As the temperature sensor, for example, a thermistor may be used. The output of the temperature sensor can be used to control the flow rate more accurately.

As the control valves 14a, 14b, for example, a piezoelectric element driven valve composed of a metal diaphragm as the valve element and a piezoelectric element (piezo actuator) as the driving device is used. The piezoelectric element driven valve is configured to be able to arbitrarily change the opening degree according to the driving voltage applied to the piezoelectric element, and to adjust the opening degree to an arbitrarily by controlling the driving voltage. For the inflow pressure sensor 17, the first pressure sensors 15a, 15b, and the second pressure sensor 18, a type of pressure sensor that incorporates a single-crystal silicon diaphragm and a sensor chip attached to it is used.

Furthermore, the flow rate control device 10 has a control circuit 19. The control circuit 19 includes a CPU provided on a circuit board, a memory (storage device) such as ROM or RAM, an A/D converter, etc., and contains a computer program configured to perform the operations described later. The control circuit 19 is realized by a combination of hardware and software. In this embodiment, the control circuit 19 is configured to perform flow rate control by feedback control of the control valve based on the upstream pressure P1 in normal flow rate control.

Furthermore, the control circuit 19 is configured to be able to detect seat leak in the control valves 14a, 14b based on the temporal measurement results of the supply pressure P0, the downstream pressure P2 (or upstream pressure P1) during seat leak detection. Some or all of the components of the control circuit 19 may be provided outside the flow rate control device 10 and may be provided as a part of an external control unit that controls the operation of the upstream on-off valve V1 and the downstream on-off valve V2.

In this configuration, the first path 13a is used as the control path for flowing gas at large flow rate, and the second path 13b is used as the control path for flowing gas at small flow rate. Typically, the diameter of the restriction part 16a provided in the first path 13a is formed larger than the diameter of the restriction part 16b provided in the second path 13b. As the restriction parts 16a, 16b, for example, an orifice plate, a critical nozzle, or a slit structure may be used. The diameter of the orifice or nozzle is set to, for example, 10 μm to 2500 μm.

In the flow rate control device 10, by completely closing the control valve 14b and adjusting the opening degree of the control valve 14a based on the output of the first pressure sensor 15a (upstream pressure P1), gas can be supplied at a controlled flow rate in the high flow range. Also, by completely closing the control valve 14a and adjusting the opening degree of the control valve 14b based on the output of the first pressure sensor 15b (upstream pressure P1), gas can be supplied at a controlled flow rate in the low flow range. When the maximum flow rate that can be controlled by the flow rate control device 10 is set to 100% (full-scale flow rate), the first flow path 13 a for high flow is used for flow rate control in the range of, for example, 5 to 100%, and the second flow path 13 b for low flow is used for flow rate control in the range of, for example, 0.1 to 5%.

In the flow rate control device 10, flow control can be performed by the same method as that of the known pressure type flow rate control device. Specifically, under a critical expansion condition (P1≥ about 2×P2: in the case of argon gas), the flow rate Q=K1·P1 (where K1 is a proportionality coefficient dependent on the fluid species and fluid temperature) can be calculated based on the output of the first pressure sensors 15a, 15b (i.e., upstream pressure P1), and it is possible to control to the desired flow rate by feedback controlling either of the control valves 14a, 14b to match the calculated flow rate with the set flow rate.

Furthermore, under a non-critical expansion condition, the flow rate Q=K2·P2^{m}(P1−P2)ⁿ (where K2 is a proportionality coefficient dependent on the fluid species and fluid temperature, and the exponents m, n are values derived from the actual flow rate) can be calculated based on the output of the first pressure sensors 15a, 15b (i.e., upstream pressure P1) and the output of the second pressure sensor 18 (i.e., downstream pressure P2), and it is possible to be controlled to the desired flow rate by feedback controlling either of the control valves 14a, 14b to match the calculated flow rate with the set flow rate.

As mentioned above, in order to ensure gas flowing through only one of the paths, it is preferable to configure the control valves 14a, 14b provided in the other flow path completely closable. For this purpose, resin made seat (for example, made of Polychlorotrifluoroethylene (PCTFE)) may be used as the control valves 14a, 14b. Using resin made seats can improve the airtightness when the control valves are closed, thus facilitating the switching of the flow paths. Additionally, thin resin films may be formed on the contact surfaces between the seats and the valve elements (metal diaphragm) of the control valves 14a, 14b.

Hereinafter, the seat leak detection method according to this embodiment is explained. The seat leak detection is performed in a manner same as the method shown in the comparative examples in FIG. 2(a), 2(b), and 3, by first closing the opened upstream on-off valve V1 and the downstream on-off valve V2, and inputting a 0% set flow rate (or a control valve forced closing signal) to the flow rate control device 10. This results in a state where the upstream on-off valve V1, the downstream on-off valve V2, and the control valves 14a, 14b are all closed.

Then, same as the method of the comparative example shown in FIG. 3, the first pressure measurement of the supply pressure P0 and the downstream pressure P2 (or upstream pressure P1) is performed at the time t0 (the first time) when waiting period for the pressure stabilization is completed. Then, at the time t1 (the second time) after a predetermined time Δt has elapsed, pressure variations ΔP0 (=P0₁−P0₂) and ΔP2 (=P2₂−P2₁) are detected, and the presence of a seat leak is determined by whether both magnitudes exceed their respective thresholds. If a seat leak is not confirmed in the first detection, the second and subsequent detections are carried out after the predetermined time At has elapsed in the same manner.

In these detections, when a seat leak occurrence was determined, traditionally, an alarm was issued at that point and the operation of the device was terminated. Seat leak may occur in either one or both of the control valves 14a and 14b, so it can be determined that the flow rate control accuracy decreased. In contrast, in this embodiment, even when a seat leak occurrence is determined, an alarm is not issued immediately to terminate the operation of the device, but a re-detection is conducted after a predetermined time has elapsed.

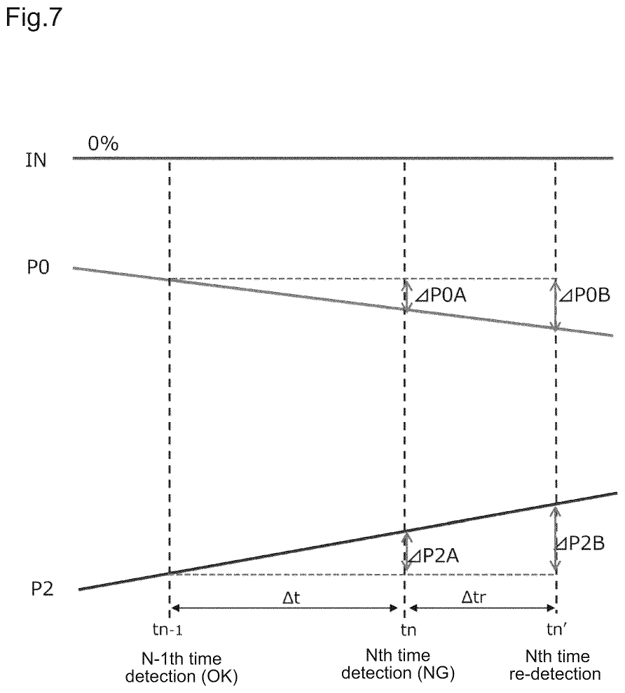

FIG. 7 shows a case where no seat leak (OK) was determined until the N-1th time detection, but in the Nth time detection, the pressure variation ΔP0A of the supply pressure P0 exceeded the predetermined threshold, and the pressure variation ΔP2A of the downstream pressure P2 also exceeded the predetermined threshold, leading to a suspicion of seat leak (NG).

As shown in FIG. 7, in this embodiment, if NG is determined at the Nth time detection, a re-detection of the Nth detection is conducted at the time tn′ (the third time) after an additional waiting time Δtr. At this time, the additional waiting time Δtr is typically set to a value smaller (for example, less than half) than the predetermined time Δt, which is the normal detection interval. Also, the additional waiting time Δtr is typically set longer than the control delay time that may occur when returning to the normal flow rate control operation mentioned above. The additional waiting time Δtr may be set, for example, to 1 to 5 seconds, and may be set as a parameter value that can be arbitrarily changed later.

Here, the seat leak detection method of this embodiment validates the detection only when the set flow rate input IN is 0%, and invalidates the detection when the set flow rate input IN is an arbitrary Y% flow rate other than 0% (i.e., IN ≠0%). Therefore, when transitioning to flow rate control at the Y% flow rate as shown in FIG. 4, it is expected that the set flow rate input IN will not to be determined as 0% at the timing of the re-detection after the additional waiting time Δtr has elapsed, and the detection itself will be deemed invalid (no detection conducted). Thus, it is possible to prevent false detection of seat leak caused by the pressure change due to control delays during the transition to normal flow rate control, rather than caused by seat leak.

Furthermore, in the re-detection, as shown in FIG. 7, Whether there is a seat leak and whether to activate an alarm is determined by whether both of the pressure variations ΔP0B and ΔP2B, which are obtained from the pressure measurement values of the N-1th time detection and the re-detection, exceed the predetermined thresholds. In this situation, if a seat leak actual occurs, it is assumed that not only the pressure variations ΔP0A and ΔP2A during the initial detection but also the pressure variations ΔP0B and ΔP2B during the re-detection exceed the thresholds. Therefore, it is possible to properly detect a seat leak and issue an alarm.

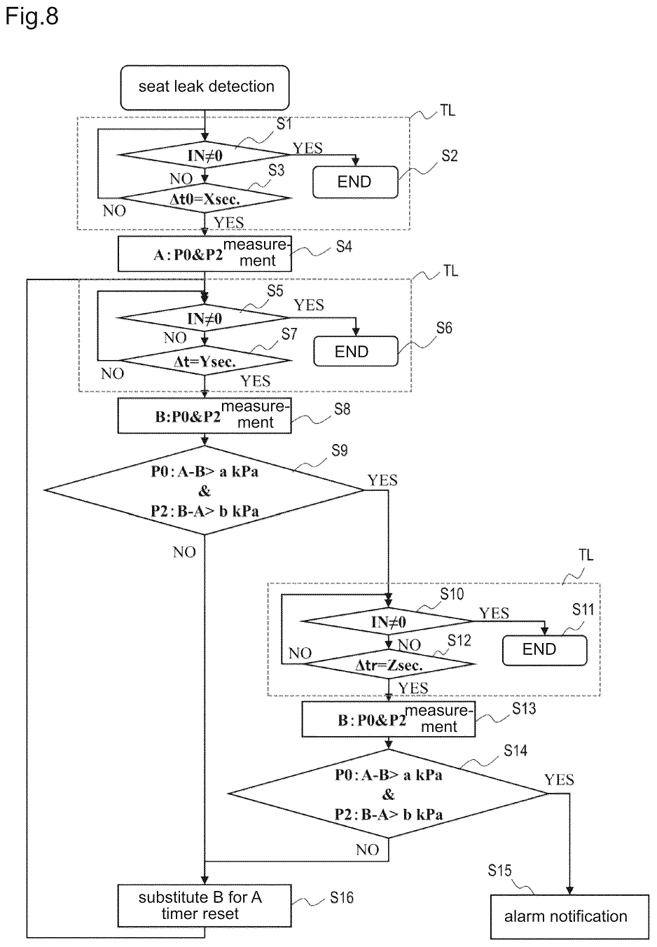

FIG. 8 is a flowchart showing the procedure for the seat leak detection method according to this embodiment. First, when the seat leak detection flow starts, as shown in Step S1, whether the set flow input IN is other than 0% is determined. Here, if IN is other than 0% (YES in Step S1), the process does not proceed to leak detection and terminates the detection flow as shown in Step S2.

On the other hand, in Step S1, if the set flow input IN is 0% (NO in Step S1), as shown in Step S3, a waiting time has elapsed by a timer loop TL until the initial time Δt0 reaches a set stabilization waiting time X. The stabilization waiting time X is, for example, 1 second.

Then, when the stabilization waiting time X is reached (YES in Step S3), the first pressure measurement is performed as shown in Step S4. In this embodiment, the supply pressure P0 and downstream pressure P2 are measured, and their values (here referred to as value A) are stored in memory.

Next, as shown in Step S5, whether the set flow input IN is other than 0% is determined again, and if the set flow input IN is other than 0%, the flow of seat leak detection is terminated as shown in Step S6.

On the other hand, in Step S5, if the set flow input IN is 0%, as shown in Step S7, a waiting time has elapsed by the timer loop TL until the time Δt reaches a set detection interval Y. Then, when the detection interval Y is reached, as shown in Step S8, the supply pressure P0 and the downstream pressure P2 are measured, and their values (here referred to as value B) are stored in memory. The detection interval Y is, for example, 45 seconds.

Next, as shown in Step S9, the supply pressure P0 and the downstream pressure P2 are compared with the obtained pressure measurement values A and B respectively to determine whether there is seat leak. In this example, it is determined whether both of the two conditions are satisfied: for the supply pressure P0, whether the pressure variation A-B exceeds the threshold a, and for the downstream pressure P2, whether the pressure variation B-A exceeds the threshold b. Here the threshold a is, for example, 1.0 kPa, and the threshold b is, for example, 1.5 kPa.

If no seat leak in Step S9 is determined, as shown in Step S16, B is substituted for the previous value A, while the timer is reset, and the process returns to Step S5. This allows the next detection to continue after the set detection interval Y has further elapsed under the condition that the set flow input IN is 0%.

On the other hand, in Step S9, if both conditions are satisfied, a seat leak occurrence is suspected, but in this embodiment, instead of issuing an alarm immediately, it is treated as an alarm trigger and transitions to the re-detection flow of Steps S10 to S14. Steps S10 to S14 are parts added in the new firmware used in the detection method of this embodiment. In the detection method of the comparative example mentioned above, when YES is determined in Step S9, it directly transitions to the step of issuing an alarm in step S15.

In this re-detection flow, first, as shown in step S10, whether the set flow rate input IN is other than 0% or not is determined. If the set flow rate input IN is other than 0%, as shown in step S11, the seat leak detection flow is terminated.

On the other hand, if the set flow rate input IN is 0% in step S10, as shown in step S11, the seat leak detection flow is continued. Then, in order to perform re-detection, as shown in step S12, a waiting time has elapsed by the timer loop TL until an additional waiting time Δtr reaches an extension time Z. The extension time Z is, for example, 5 seconds.

During the timer loop until the additional waiting time Δtr has elapsed, if a set flow rate input IN other than 0% is confirmed in step S10, the seat leak detection flow is terminated and proceeded to step S11. Thus, at the timing showing in FIG. 4, when a seat leak being determined once in step S9, even if the set flow rate input IN transitions to Y% thereafter due to control delay (usually less than a few seconds), the flow can be terminated in step S11 by a branch from step S10. Therefore, it is possible to prevent false detection that occurred due to pressure variations ΔP0 and ΔP2 exceeding the threshold values even though there was actually no seat leak.

After the additional waiting time Δtr has elapsed, in step S13, the supply pressure P0 and the downstream pressure P2 are re-measured, and their values (here, referred to as updated value B) are stored in memory. Then, in step S14, each of the supply pressure P0 and the downstream pressure P2 are compared with the obtained pressure measurement values A and B (updated value) to determine the presence or absence of seat leak. In this example, the determination made in step S14, except for using the updated value B, is the same as the determination made in step S9. However, it is not limited to this, and in step S14, different thresholds or determination formulas than those at step S9 may be used.

If a seat leak is also determined in the re-detection in step S14, as shown in step S15, an alarm is issued to notify the user, typically terminating the operation of the device. The notification alarm in step S15 may be, for example, by sound or light, or by displaying a warning on the screen of a terminal used by the user, so that the user can recognize the occurrence of a seat leak and be aware of the malfunction in the flow rate control.

On the other hand, if no seat leak is determined in step S14, it is judged that the determination in step S9 was an accidental false detection, and then proceed to step S16, where B is substituted for A indicating the previous value, and the timer is reset, and then returns to step S5. This allows for the continuation of the next detection after the set detection interval Y has further elapsed under the condition that the set flow rate input IN is 0%.

As described above, the seat leak detection method according to this embodiment can prevent false detection and more accurately detect seat leak in control valve. Furthermore, in the event of a seat leak, the supply pressure P0 decreases over time, and the downstream pressure P2 increases. Based on the rate of decrease in supply pressure P0 or the rate of increase in downstream pressure P2, it is also possible to estimate the leak flow rate caused by the seat leak. For example, considering the rate of pressure decrease ΔP0/Δt is proportional to the leak flow rate, and more specifically, the leak flow rate Q can be estimated from Q=(1000/760)×60×(273/(273+T))×V×(ΔP0/Δt). Here, T is the gas temperature (° C.), ΔP0 is the magnitude of the pressure drop (Torr), and Δt is the time (sec) needed for the pressure drop ΔP0. Also, V is the total volume (liters) of the flow path between the upstream on-off valve V1 and the control valves 14a, 14b.

In the above embodiment, the presence of seat leak is detected by referring to the measurement results of both the supply pressure PO and the downstream pressure P2. This is because, in a maintenance mode where the set flow rate is 0%, the common inflow path 11 may be vacuumed, which causes a forced decrease in supply pressure P0. In this case, if only the supply pressure P0 is referred to, there is a risk of falsely detecting a seat leak even though there is actually no seat leak in the control valve. By referring to both the supply pressure P0 and the downstream pressure P2, the presence of seat leak can be detected more accurately. However, depending on the situation, it may also be possible to detect seat leak by monitoring either the supply pressure P0 or the downstream pressure P2.

In the above aspect, although the downstream pressure P2 is referred to, in a seat leak detection process, the upstream pressure P1 and the downstream pressure P2 can be considered equivalent. Therefore, it is also possible to detect seat leak by referring to the upstream pressure P1 instead of the downstream pressure P2. However, by referring to the downstream pressure P2, which is the output of the second pressure sensor 18 used for controlling both low and high flow rates, the risk of false detection is reduced even if there are characteristic differences in the first pressure sensors 15a, 15b.

Furthermore, the determination of the presence of seat leak is not limited to comparing the pressure variations ΔP0 and ΔP2 with corresponding thresholds (pressure values). The presence of seat leak can also be detected by comparing the slope of change ΔP0/Δt in the supply pressure P0 and the slope of change ΔP2/Δt in the downstream pressure P2 with the predetermined threshold. In this case, Y may be used as Δt in the step S9 shown in FIG. 8, and Y+Z may be used as Δt in step S14.

While embodiments of the present invention have been described above, various modifications are possible. For example, although the pressure sensor used in the pressure type flow rate control device is utilized for seat leak detection in the above embodiment, similar seat leak detection is possible even without a pressure type flow rate control device, by providing on-off valves upstream and downstream of the flow rate control device and pressure sensors before and after the control valve. In addition to the above, although the seat leak detection method in control valves for parallel two flow paths has been described, it is also possible to detect seat leak in a flow control device having three or more parallel flow paths using the same procedure. Furthermore, it is not always necessary to have parallel flow paths, seat leak in a control valve can also be detected using the same procedure even when only one control flow path is provided.

### Industrial Applicability

The seat leak detection method according to the embodiments of the present invention is suitably used in detecting a seat leak in a control valve, for example, in a fluid system including a flow rate control device.

### REFERENCE SIGNS LIST

2 Gas supply source
4 Process chamber
6 Vacuum pump
10 Flow rate control device
11 Common inflow path
12 Common outflow path
13a First flow path (parallel path)
13b Second flow path (parallel path)
14a, 14b Control valve
15a, 15b First pressure sensor (upstream pressure sensor)
16a, 16b Restriction part
17 Inflow pressure sensor
18 Second pressure sensor (downstream pressure sensor)
19 Control circuit
100 Fluid system
V1 Upstream on-off valve
V2 Downstream on-off valve
P0 Supply pressure
P1 Upstream pressure
P2 Downstream pressure

1. A seat leak detection method of a control valve performed in a fluid system comprising:
a flow rate control device including a restriction part; a control valve provided upstream of the restriction part; a control flow path having a first pressure sensor provided between the control valve and the restriction part for measuring an upstream pressure; a second pressure sensor provided downstream of the restriction part for measuring a downstream pressure; and an inflow pressure sensor provided upstream of the control valve for measuring a supply pressure;
a downstream on-off valve provided downstream of the second pressure sensor; and
an upstream on-off valve provided upstream of the inflow pressure sensor, the seat leak detection method comprising:
a step (a) of closing the upstream on-off valve and the downstream on-off valve, and inputting a set flow rate of 0% or a control valve forced close signal to the flow rate control device, in a state where the supply pressure is greater than the downstream pressure;
a step (b) of measuring at least one of the supply pressure, the upstream pressure, and the downstream pressure at a first time point after step (a) by using at least one of the inflow pressure sensor, the first pressure sensor, and the second pressure sensor;
a step (c) of measuring at least one of the supply pressure, the upstream pressure, and the downstream pressure at a second time point after the first time point, and
a step (d) of detecting seat leak of the control valve based on a pressure variation of at least one of the supply pressure, the upstream pressure, and the downstream pressure measured in the steps (b) and (c), wherein
the step (d) includes:
a step of monitoring whether a set flow rate other than the set flow rate of 0% or a signal input other than the control valve forced close signal has been input between the second time point and a subsequent third time point, in a case where the pressure variation of at least one of the supply pressure, the upstream pressure, and the downstream pressure between the first time point and the second time point exceeds a threshold;
a step of terminating the seat leak detection flow when the set flow rate other than the set flow rate of 0% or the signal other than the control valve forced close signal is input between the second point and the third time point;
a step of re-measuring at least one of the supply pressure, the upstream pressure, and the downstream pressure at the third time point, when the set flow rate of 0% or the control valve forced close signal is maintained between the second time point and the third time point; and
a step of detecting seat leak using at least one of the supply pressure, the upstream pressure, and the downstream pressure measured at the third time point.

2. The seat leak detection method according to claim 1, wherein multiple control flow paths are provided in parallel between a common inflow path and a common outflow path.

3. The seat leak detection method according to claim 1, wherein measurements of the supply pressure and the downstream pressure are performed at the first time point, the second time point, and the third time point, and seat leak is detected based on both a pressure variation of the supply pressure and a pressure variation of the downstream pressure.

4. The seat leak detection method according to claim 2, wherein measurements of the supply pressure and the downstream pressure are performed at the first time point, the second time point, and the third time point, and seat leak is detected based on both a pressure variation of the supply pressure and a pressure variation of the downstream pressure.

5. The seat leak detection method according to claim 1, further comprising a step of issuing an alarm when a seat leak is detected.

6. The seat leak detection method according to claim 1, wherein the step (d) includes detecting seat leak based on a pressure variation calculated from at least one of measurement results of the supply pressure, the upstream pressure, and the downstream pressure at the third time point, and at least one of measurement results of the supply pressure, the upstream pressure, and the downstream pressure at the first time point.

7. The seat leak detection method according to claim 1, wherein if no seat leak occurrence has been determined in the step (d) based on the pressure variation of at least one of the supply pressure, the upstream pressure, and the downstream pressure measured in the steps (b) and (c), detection is repeated during a period when a set flow rate of 0% is maintained by performing measurement of at least one of the supply pressure, the upstream pressure, and the downstream pressure again after the detection interval, which is a time period from the first time point to the second time point.
